(19) United States
(12) Patent Application Publication
(10) Pub. No.: US 2006/0244165 A1
(43) Pub. Date: Nov. 2, 2006

(54) Manufacturing carbon fiber reinforced ceramics as brake discs

(76) Inventor: Dai Huang, Hong Kong (HK)

Correspondence Address: WADDEY & PATTERSON, 1600 DIVISION STREET, SUITE 500, NASHVILLE, TN, 37203, US

(21) Appl. No.: 11/115,551

(22) Filed: Apr. 27, 2005

(51) Int. Cl. C01B 31/00

(52) U.S. Cl. 264/29.5

(57) ABSTRACT

A carbon fiber reinforced ceramic brake disc or pad is formed from a rapidly hot-pressed carbon/carbon composite material. First, a reinforcement material, preferably including carbon fibers, is combined with a carbonizable matrix material to form a green preform. The green preform is heated and a portion of the matrix material is at least partially carbonized so as to form a carbon/carbon composite. Optionally, a carbonizable material is introduced into voids in the carbon/carbon composite. The product is then heated to carbonize the carbonizable material. The carbonizable material infiltration and baking steps are optionally repeated to increase the density of the composite. A pre-ceramic polymer material is introduced into voids of the carbon/carbon composite and heat-treated so as to pyrolytically decompose the pre-ceramic polymer. Finally, the carbon/ceramic composite is then high-temperature heat treated so as to form a carbon fiber reinforced ceramic material.

### BACKGROUND OF THE INVENTION

The present application relates to a method for forming carbon reinforced fiber ceramic structures suitable for high temperature, friction-bearing applications. The present application relates more particularly to a method for forming carbon reinforced fiber ceramics from at least partially carbonized carbon/carbon composite materials. It finds particular application in conjunction with a carbon fiber reinforced ceramic material formed from a carbonized carbon/carbon composite material which itself is formed by resistance heating of combinations of carbon fiber and binder/matrix materials during application of a compressive force and will be described with particular reference thereto.

Methods of manufacturing reliable friction-bearing ceramic structures are difficult, time consuming and expensive. Ceramic structures are desirable because of their exceptional high-temperature performance, relative lightness of weight, extreme hardness, and high wear resistance. However, most ceramic structures are also brittle and difficult to manufacture without defects. Carbon fiber reinforced ceramics (“CFRC”) are one type of recently developed ceramic structures with improved toughness and crack resistance.

Particularly useful articles of manufacture embodying CFRC friction-bearing ceramic structures include vehicle disc brake systems having CFRC brake discs and CFRC brake pads. These brake systems have high coefficients of friction and excellent friction characteristics across a wide range of operating temperatures. Typical coefficients of friction for CFRC brake pads are in the range between 0.5 and 0.9, under JIS D4411 test conditions. By comparison, conventional resin mold brake pads have typical coefficients of friction in the range between 0.3 and 0.4 and carbon/carbon composite brake pads have typical coefficients of friction in the range between 0.4 and 0.5.

One method of forming CFRC structures such as brake pads and discs begins with mixing a ceramic oxide material such as mullite (a refractory material having a nominal composition of 3Al₂O₃.2SiO₂) with an organometallic polymer to form a coating slurry. Long carbon fibers are immersed in the coating slurry so as to deposit the slurry uniformly on the surface of the fibers. The coated carbon fibers are cut into a desired length. Multiple layers of the coated carbon fibers are assembled in a mold of a heated press by layering one after another, each time changing the orientation of the fiber until the resulting laminate has a predetermined thickness. The laminate is then heated under an inert gas atmosphere to make the organometallic polymer infusible, and then shaped to a die, followed by baking under pressure by a hot press under an inert gas atmosphere.

The organic component of the organometallic polymer is pyrolytically decomposed and fine particles of metal carbide or nitride ceramics are uniformly dispersed throughout the mullite grain boundary, whereby a carbon fiber reinforced ceramic composite is further reinforced by the particles dispersed therein. The resulting CFRC material would have improved fracture toughness in comparison to previously known non-CFRC ceramic materials.

Other methods of forming CFRC structures include of depositing pre-ceramic polymers upon carbon fiber reinforced structures through other well known methods such as melt infiltration, sintering and conventional chemical vapor deposition or infiltrations (CVD/CVI).

However, the lengthy heating and infiltration times render the above identified methods of manufacturing CFRC structures expensive and often impractical for many applications. Moreover, in the simple mixing method described, the bonding of the carbon fibers and the binder of the pre-ceramic polymer coating slurry are not optimal. Similarly, the pyrolysis processes of these methods produce less than optimal SiC/C bonding.

The present invention provides a new and improved method of forming dense CFRC friction-bearing ceramic structures, such as a CFRC brake discs or CFRC brake pads, which overcomes the above-referenced problems and others, and provides advantages over the above-identified methods.

### SUMMARY OF THE INVENTION

In accordance with one aspect of the present invention, a method of forming a CFRC material is provided. The method includes impregnating an at least partially carbonized carbon/carbon composite with a pre-ceramic polymer. The pre-ceramic carbon/carbon composite is then heat-treated so that the pre-ceramic polymer is pyrolytically decomposed. Finally, the carbon/ceramic composite is then subjected to a final high-temperature heat treatment so as to form a carbon fiber reinforced ceramic material.

In accordance with another aspect of the present invention, a method of forming a CFRC material from a rapidly hot-pressed carbon/carbon composite material is provided. The method includes a first step of forming an at least partially carbonized carbon/carbon composite material by combining a reinforcement material that preferably includes carbon-containing fibers, with a carbonizable matrix material to form a green preform or mixture. The green preform or mixture is heated to a temperature sufficient to heat pyrolyze at least a portion of the matrix material so as to form an at least partially carbonized carbon/carbon composite. In optional steps, a carbonizable material is introduced into voids in the carbon/carbon composite. The product is then heated to carbonize the carbonizable material so as to increase the density of the carbonized carbon/carbon composite. The carbonizable material infiltration and baking steps are optionally repeated. The carbonized carbon/carbon composite is then subjected to one or more infiltration and baking steps employing a pre-ceramic polymer to introduce SiC into the matrix. In a pre-ceramic polymer infiltration step, a pre-ceramic polymer material is introduced into voids in the carbon/carbon composite. The resulting pre-ceramic carbon/carbon composite is then heat-treated to pyrolytically decompose the pre-ceramic polymer. Finally, the carbon/ceramic composite is then subjected to final high-temperature heat treatment so as to form a carbon fiber reinforced ceramic material.

In accordance with another aspect of the present invention, a method of forming a CFRC brake pad or disc is provided. The method includes compressing a green preform or mixture of carbon fibers and a matrix material that includes pitch in a hot press mold cavity. During the step of compressing, a current is applied to the green preform or mixture. The green preform or mixture provides sufficient electrical resistance to the current such that the green preform or mixture reaches a temperature of at least 500° C. to drive off volatile, components and form a compressed preform. A carbonizable material is optionally introduced into voids in the compressed preform to form an impregnated preform. The product is heated to carbonize the carbonizable material and increase the density of the preform. The infiltration and baking steps are optionally repeated to form a densified preform. The densified preform is then subjected to one or more pre-ceramic polymer infiltration steps to introduce SiC precursor into the matrix. In a pre-ceramic polymer infiltration step, a pre-ceramic polymer material is introduced into voids in the carbon/carbon composite. The pre-ceramic polymer impregnated carbon/carbon composite preform is then heat-treated to a temperature between about 1000° C. and about 1700° C. to pyrolytically decompose the pre-ceramic polymer. The ceramic preform is heat-treated to a final temperature of about 1500° C. to about 2500° C. to form a finished CFRC material.

An advantage of at least one embodiment of the present invention is that CFRC structures, such as brake components, are formed in much shorter periods of time than by conventional methods.

Another advantage of at least one embodiment of the present invention is that the pre-ceramic polymer impregnation and pyrolysis process achieves a greater degree of SiC/C bonding than conventional methods of forming CFRC structures.

Another advantage of at least one embodiment of the present invention is that the pre-ceramic polymer impregnation and pyrolysis process preserves the superior thermal conductivity and mechanical properties of carbon fiber since no carbon is consumed or reacted during the pre-ceramic polymer impregnation and pyrolysis process or the subsequent high-temperature heat treatment process.

Still further advantages of the present invention will be readily apparent to those skilled in the art, upon a reading of the following disclosure and a review of the accompanying drawings.

### BRIEF DESCRIPTION OF THE DRAWINGS

FIG. 1 is a flow chart showing steps of an exemplary process scheme for forming a carbon fiber reinforced ceramic material according to the present invention.

FIGS. 2A-2F are details of the flow chart of FIG. 1 showing alternative exemplary process schemes of the steps of the green preform formation stage.

FIG. 3 is a detail of the flow chart of FIG. 1 showing the alternative exemplary process schemes of the steps of the hot pressing and densification stage.

FIG. 4 is a detail of the flow chart of FIG. 3 showing an exemplary process scheme of the compressive molding and resistive heating steps of the hot pressing and densification stage.

FIG. 5 is a detail of the flow chart of FIG. 1 showing an exemplary process scheme of the steps of the ceramic conversion stage and the high-temperature heat treatment stage.

### DETAILED DESCRIPTION OF THE INVENTION

A method of forming a CFRC material suitable for use in thermal structural applications, such as friction components, is provided by impregnating an at least partially carbonized carbon/carbon composite preform with a pre-ceramic polymer. The pre-ceramic polymer impregnated carbon/carbon composite is then heat-treated so that the pre-ceramic polymer is pyrolytically decomposed. Finally, the carbon/ceramic composite preform is high-temperature heat treated so as to form a carbon fiber reinforced ceramic body.

The carbon/carbon composite material is formed by resistance heating of a mixture of a carbon-based reinforcement material, such as carbon fibers, and a matrix material, such as powdered pitch. The resistive heating step is accompanied by application of mechanical pressure to density the mixture. After hot-pressing, the compressed composite or “preform” is preferably subjected to one or more cycles of infiltration and baking steps employing a carbonizable resin, pitch or other suitable impregnants to increase the density of the composite material. The densified preform is subjected to one or more infiltration and baking steps employing a pre-ceramic polymer to introduce ceramics such as SiC into the matrix. In a pre-ceramic polymer infiltration step, a pre-ceramic polymer material is introduced into voids in the carbon/carbon composite. The pre-ceramic polymer impregnated preform is heat-treated to a temperature of at least about 500° C. and, preferably, to a temperature between about 1500° C. and about 1700° C. to pyrolytically decompose the pre-ceramic polymer. The ceramic preform is heat-treated to a final temperature of up to about 2500° C. to remove remaining non-ceramic, non-carbon components, such as hydrogen and heteroatoms (e.g., nitrogen, sulfur, and oxygen), and form a carbon fiber reinforced ceramic material that is substantially carbon.

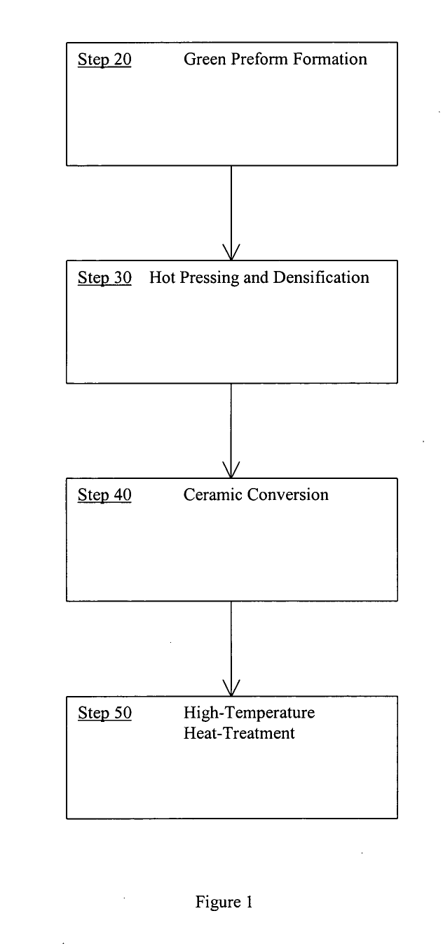

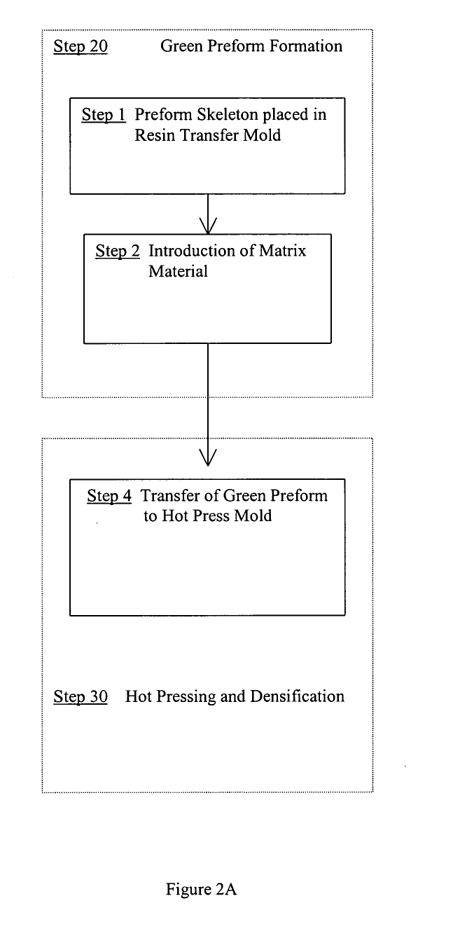

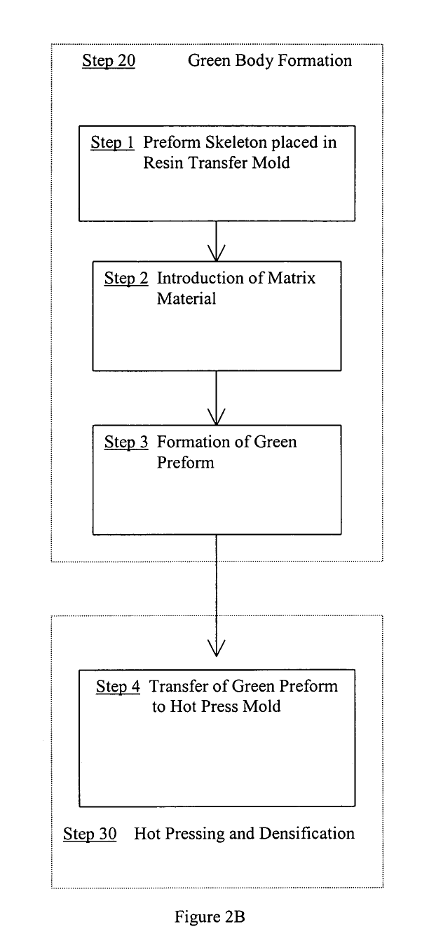

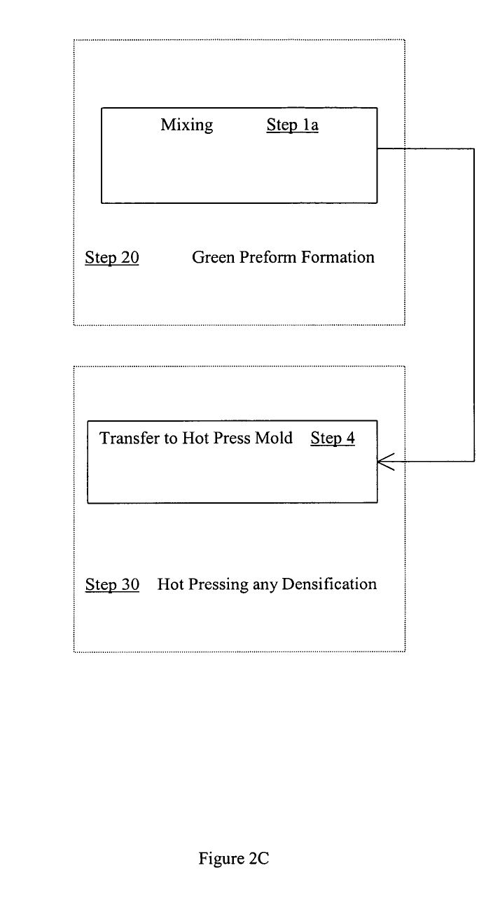

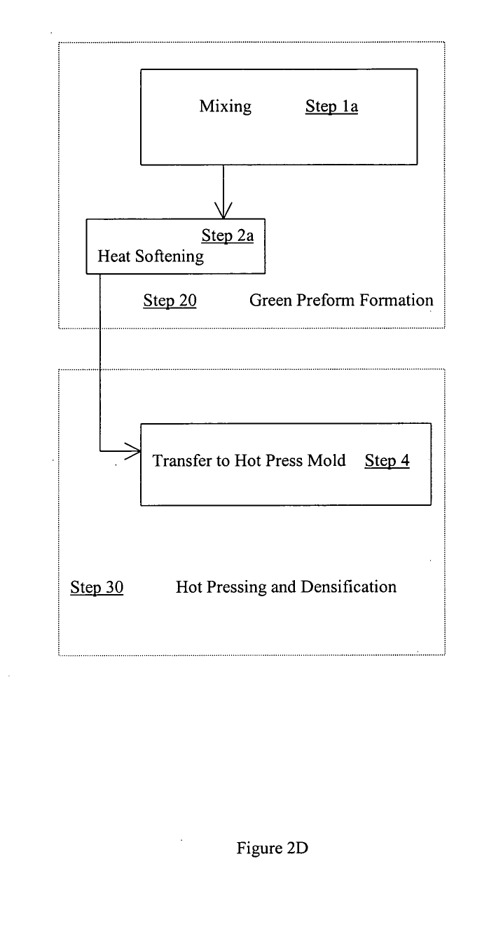

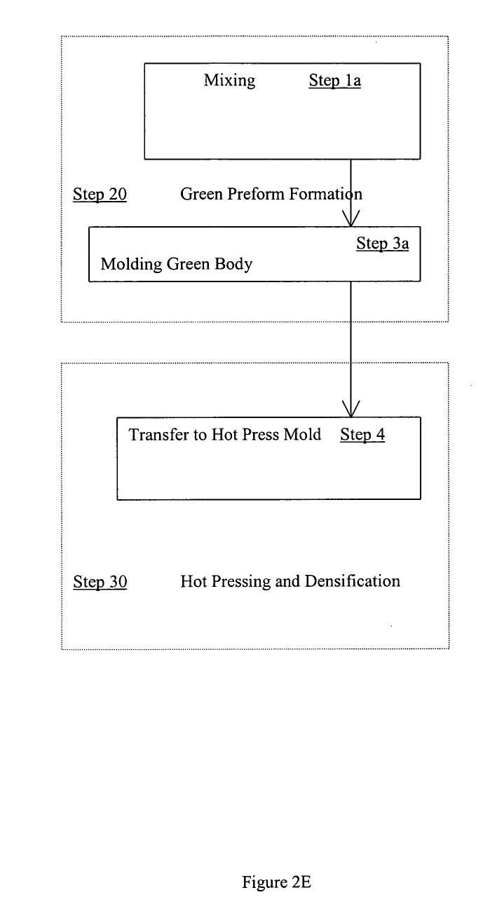

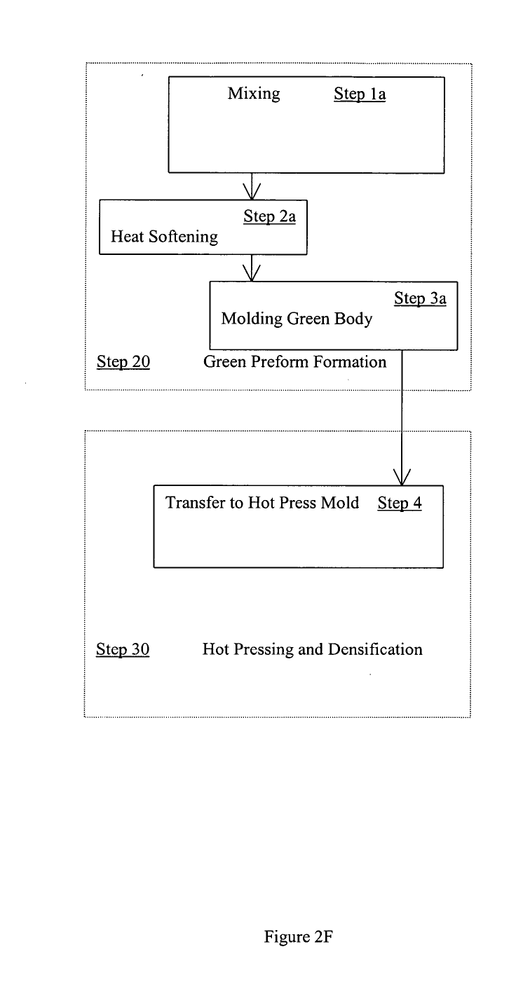

With reference to FIG. 1, a flow chart representing the sequence of stages of an exemplary process scheme of this inventive process for the manufacture of CFRC bodies, such as CFRC brake pads or CFRC brake discs, is shown. As used herein, the term “stage” refers to a sequence of one or more steps. Generally, carbon-based reinforcement material components are combined with carbon matrix materials and other additives in a green preform formation stage (Step 20) and the resulting green preform is then at least partially carbonized in a hot pressing and densification stage (Step 30) to produce a carbon/carbon composite preform. Optionally, the hot pressed preform is impregnated with a carbonizable material and baked to carbonize the carbonizable material to increase the density of the preform. The carbonizable material infiltration and baking steps are optionally repeated to further increase the density of the densified preform. A pre-ceramic polymer material is introduced into the preform matrix and then decomposed pyrolitically in a ceramic conversion stage (Step 40). Finally, the carbon/ceramic body is heat-treated in a high-temperature heat treatment stage (Step 50). With reference to FIGS. 2A-2D, 3, 4, and 5, flow chart details representing alternative sequences of steps of the various stages of this inventive process are shown.

In the green preform formation stage (Step 20), a carbon reinforcement material, preferably including carbon fibers, is combined with a matrix material, preferably including a pitch or a resin, to form a green preform. Preferably, the carbon fibers are bonded with the matrix material in a resin transfer molding process or, more preferably, in a vacuum assisted resin transfer molding process. Alternatively, the carbon fibers are bonded with the matrix in a mixing process. Generally, resin transfer processes, and in particular vacuum-assisted resin transfer processes, create better bonding between the carbon fiber and the binder than simple mixing processes. Additionally, the void content of a resin transfer perform is very low. Resin transfer molding reduces manufacturing cycle times and can be adapted for use as one stage in an automated, repeatable manufacturing process for even greater efficiency, reducing cycle time from what is typically required for mixing processes.

Referring now to FIGS. 1 and 2A, in Step 1, a carbon reinforcement material, preferably including carbon fibers, is formed into a preform skeleton and positioned within a resin transfer mold. In Step 2, a matrix material, such as resin or pitch, is introduced within the resin transfer mold and upon the preform skeleton so as to cover the carbon fibers. For example, in one embodiment of Step 2, resin and, optionally, additives such as a catalyst and friction additives, are metered, mixed and, optionally, heated in dispersing equipment. The resin mixture is then introduced into the resin mold under pressure through injection ports, following pre-designed paths through the preform skeleton. Preferably, low-viscosity resin is used to permeate the preform skeleton quickly and evenly. Preferentially, in Step 2, resin is drawn into a preform through use of a vacuum, rather than pumped in under pressure. Referring now to FIGS. 1 and 2B, in an optional Step 3, the resin permeated preform skeleton is heated, as necessary, to activate polymerization reactions that solidify the liquid resins so as to form the green preform. In an alternative embodiment of the process, the matrix material includes low-viscosity melts of finely comminuted solids such that in the optional Step 3 the resin permeated preform skeleton is cooled, as necessary, to solidify the liquid resins so as to form the green preform. Referring now to FIGS. 1, 2A and 2B, in Step 4 the green preform is transferred to a hot press mold prior to being hot pressed as described below.

While the green preform is readily formed in the shape of a brake disc, a brake pad or even a rectangular block, it is also contemplated that the resin transfer mold and the preform skeleton may be configured to produce a green preform of a cylindrical or other shape, thereby reducing or eliminating the need for subsequent machining to form a desired component part.

In forming the green preform body, the matrix material acts as a binder and a filler to fill gaps between the fibers. Other carbonizable and carbonaceous additives may be incorporated into either the preform skeleton or the resin mixture. For example, a carbon material, which is electrically more conductive than the fibers or matrix material, such as powdered graphite may be added to either the preform skeleton or the resin mixture to increase the conductivity of the green preform if the resistance is too high for current to flow during resistive heating.

Suitable carbon fibers for use as the reinforcement material include those formed from pitch, such as mesophase pitch or isotropic pitch, polyacrylonitrile (PAN), rayon, cotton, cellulose, other carbonizable materials, and combinations thereof. The particular choice of carbon fibers depends on the anticipated end use of the composite material. For example, mesophase pitch carbon fibers provide the material with good thermal conductivity, once graphitized. Composites formed from mesophase pitch carbon fibers thus provide effective heat sinks. Isotropic pitch carbon fibers exhibit a low thermal conductivity and provide good thermal insulation. PAN-based carbon fibers exhibit high strength and are thus suited to formation of structural components. The fibers may be comminuted by processes such as chopping and/or milling.

Carbon-based reinforcement materials may also take the form of continuous filament yarn, chopped yarn, or tape made from continuous filaments and are referred to as unidirectional arrays of fibers. Yarns may be woven in desired shapes by braiding or by multidirectional weaving. The yarn, cloth and/or tape may be wrapped or wound around a mandrel to form a variety of shapes and reinforcement orientations. As used herein, the term “fibers” is intended to encompass all elongated carbon-based reinforcement materials having a length that is at least twenty times, more preferably, at least 100 times the fiber diameter.

The matrix material provides an independent source of carbon upon pyrolytic decomposition. The matrix material is fusible (i.e., capable of melting) and contains both volatile and non-volatile components. The matrix material decomposes upon heating to form an infusible material that is primarily carbon with the release of volatiles. Matrix materials which may be used by resin transfer molding processes to form green composite preforms include liquids and solids which have low enough viscosity upon melting to allow flow through the resin mold channels and coating of the fibers. Preferred matrix materials include various liquid resins and pitches, and also include low-viscosity melts of finely comminuted solids of various resins and pitches. While the matrix material is described with particular reference to liquid resins and pitches, it will be appreciated that other matrix materials are also contemplated.

Alternatively, in the green preform formation stage (Step 20), the carbon fibers may be bonded with the matrix material in a mixing process. Referring now to FIGS. 1 and 2C, in Step 1a, a carbon-based reinforcement material, preferably including carbon fibers, is mixed with a matrix material. Preferably, the mixture is prepared in Step 1a by “dry mixing,” i.e., mixed without addition of solvents and at a temperature at which the matrix material is still a solid. Then, in Step 4, the dry-mixed blend is transferred to a hot press mold prior to being hot pressed as described below.

Preferred matrix materials in the mixing process of Step 1a are finely comminuted solids. Exemplary matrix materials include pitch, furan resins, and phenolic resins. Powdered pitch is a particularly preferred matrix material. Mesophase pitches and isotropic pitches with carbon yields of 60% or higher, more preferably, 70% or higher upon carbonization are particularly preferred as matrix materials. These pitches are produced from petroleum or coal tar, although it is also contemplated that the pitch matrix material may be synthetically formed. Pitch/sulfur mixtures are also suitable as matrix materials. While the matrix material is described with particular reference to milled pitch powder, it will be appreciated that other matrix materials are also contemplated.

With continued reference to FIG. 1 and now to FIG. 2F, in an optional Step 2a, the mixture is further prepared by “heat softening,” wherein heat is applied during the mixing phase to raise the temperature of the matrix material above its softening point, which, in the case of pitch, is generally between about 70° C. and about 350° C. If heat softened during mixing, then preferably the mixture is heated to about 30° C. or more above the Mettler softening point of the pitch to afford adequately low-viscosity for satisfaction mixing and wetting of carbon fibers with matrix material. While the mixing processes of Step 1a are preferably carried out in the absence of additional liquids, such as water or an organic solvent, it is also contemplated that a small amount of an organic solvent may be mixed with the matrix and reinforcement materials to act as a plasticizer for the matrix material and reduce the mixing temperature. Other methods, which involve forming a slurry with a low-boiling-point liquid and drying the slurry to form a preform, are less desirable since they require additional processing steps and thus increase overall processing time.

With continued reference to FIGS. 1 and 2F, optionally in Steps 3a and in Step 2a, the dry mixed mixture of carbon fibers and pitch powder is further prepared by “heat softening” and is then packed into a separate mold from the mold box of the hot press and pressed into a green preform having dimensions only slightly smaller than those of the hot press mold cavity. In Step 4, the resulting green preform is transferred to the cavity of the hot press mold box.

With continued reference to FIG. 1 and now to FIG. 2D, in an alternative embodiment, Step 3a is eliminated and the heat softened mixture of fibers and matrix material is transferred directly to the hot press mold box from the mixer.

With continued reference to FIG. 1 and now to FIG. 2E, in another alternative embodiment, Step 2a is eliminated. The dry-mixed blend of carbon fibers and pitch powder of Step 1a is first pressed into a green preform in Step 3a and then the green preform is transferred to the cavity of the hot press mold box in Step 4.

Referring now to FIGS. 1 and 2A-2F, the materials produced in the green preform formation stage (Step 20) and transferred to the hot press mold in Step 4 is herein termed the “hot press preform.” Depending on the particular process scheme selected, the term “hot press preform” will describe either a dry mixed mixture (FIG. 2C), a heat softened mixture (FIG. 2D) or a green preform (FIGS. 2A, 2B, 2E and 2F).

Referring again to FIG. 1, during the hot pressing and densification stage (Step 30), the hot press preform is hot pressed to create a carbon/carbon composite preform. In the hot pressing process, the hot press preform is heated to a sufficient temperature to melt at least a portion of the material. This heating step includes applying an electric current to the hot press preform such that heat is generated within the material. While heating the hot press preform, a pressure is applied to the hot press preform to form a carbon/carbon composite preform that is at least partially carbonized.

In one embodiment of the present invention, a hydraulic hot press assembly suited to resistively heat and hydraulic compress a hot press preform (i.e. the green preform or, optionally, the heat softened mixture or the dry mixed) is employed to manufacture a carbon/carbon composite preform. One exemplary hydraulic hot press assembly includes a hydraulic press having an integrally attached hot press mold, the mold having a cavity shaped to receive the hot press preform and form the desired carbon/carbon composite preform. Preferably, the hot press mold is shaped to the approximate dimensions of the desired finished CFRC body, such as a CFRC brake disc or pad. Additionally, the hot press mold is preferably contained within a thermally insulated housing. Pressure is applied to the hot press preform by hydraulic pistons, and is preferably applied so as to achieve a uniform pressure across the entire contact surface with the hot press perform. Pressure may be applied to the hot press preform by upper and/or lower vertical hydraulic pistons operating in single or double action.

In a preferred embodiment, the ends of the hot press molds are stainless steel end plates, which are in electrical contact with the hot press preform. A resistive heating system applies an electrical current to the hot press preform through these end plates. In a more preferred embodiment, the pistons and the hot press mold each have a silicon carbide surface liner and are both electrically insulated from the frame of the hydraulic hot press assembly. The resistive heating system includes a source of electrical power for providing a high current at low voltage, such as a DC supply. High AC currents are also contemplated. The DC or AC supply is electrically connected with the stainless steel end plates. The construction of the hydraulic hot press assembly is such that all parts of the hot press preform within the hot press mold cavity are subjected to a substantially uniform current flow. Resistively heating and compressively molding the hot press preform under current and pressure conditions that are generally uniform throughout the hot press preform results in substantially uniform characteristics throughout the carbon/carbon composite preform and further results in a significant reduction in fissures and other irregularities, which tend to result in fracture during use. Preferably, a programmed application of the current and pressure provides, among other things, hot press preform temperatures, pressures, heating rates and pressurization rates in accordance with a desired baking profile, the calculations of which are based upon specific hot press preform kinetics. More preferably, a programmable control system integral to the hydraulic hot press assembly provides such a programmed application of current and pressure.

Referring again to FIGS. 1 and 2A-2F, in Step 4, the hot press preform is transferred to the cavity of a hot press mold. In preferred embodiments (FIGS. 2A, 2B, 2E or 2F), a green preform is transferred to the cavity of a hot press mold. In an alternative embodiment (FIG. 2D), Step 3a is eliminated and the heat softened, hot-mixed blend is transferred directly to the hot press mold cavity from the mixer. In another alternative embodiment shown in FIG. 2C, Step 2a and Step 3a are eliminated and the dry-mixed blend is transferred directly to the hot press mold cavity from the mixer.

Referring now to FIGS. 1, 3 and 4, the hot pressing step (Step 13) includes a resistive heating step (Step 6) and a compressive molding step (Step 5) performed on the hot press preform so as to form an at least partially carbonized carbon/carbon composite preform. The resistive heating step (Step 6) is accomplished by applying an electric current to the hot press preform such that heat is generated within the hot press preform. The compressive molding step (Step 5) is accomplished by applying a pressure to the hot press preform. In one preferred embodiment the pressure is applied in a manner that results in a generally uniform pressure throughout the hot press preform.

In preferred process schemes, the hot pressing step (Step 13) includes at least a partial overlapping of the resistive heating step (Step 6) and the compressive molding step (Step 5). While the hot pressing step (Step 13) of the present invention is drawn to the exemplary process schemes shown, it is contemplated that the present invention also encompasses other process schemes, including those with no overlapping of the resistive heating step (Step 6) and the compressive molding step (Step 5). Specifically contemplated are process schemes having sequential performance of Step 6 and Step 5 or having alternating or cyclic performance of Step 6 and Step 5.

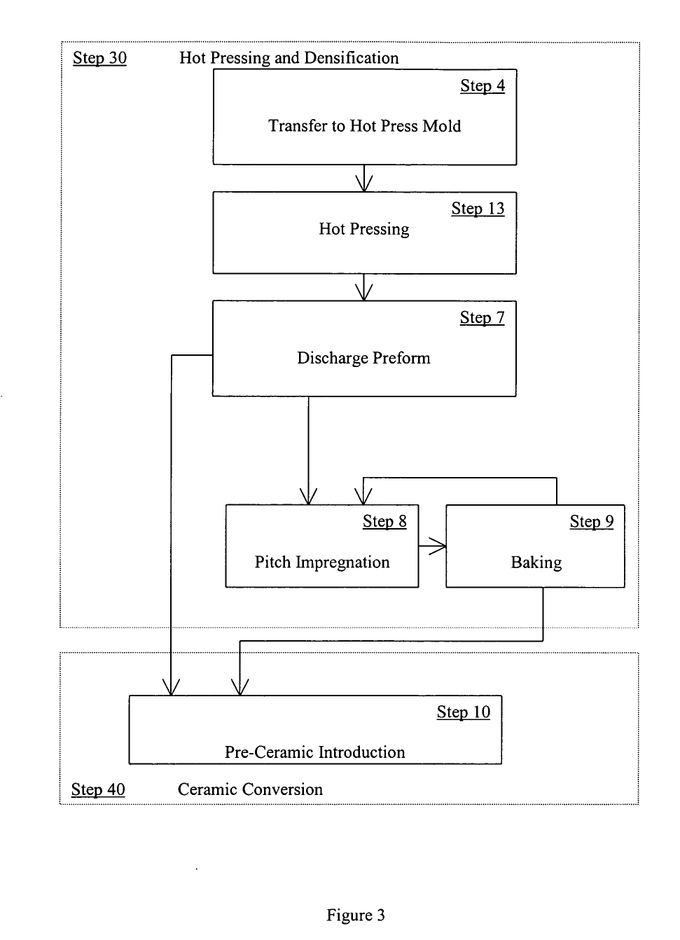

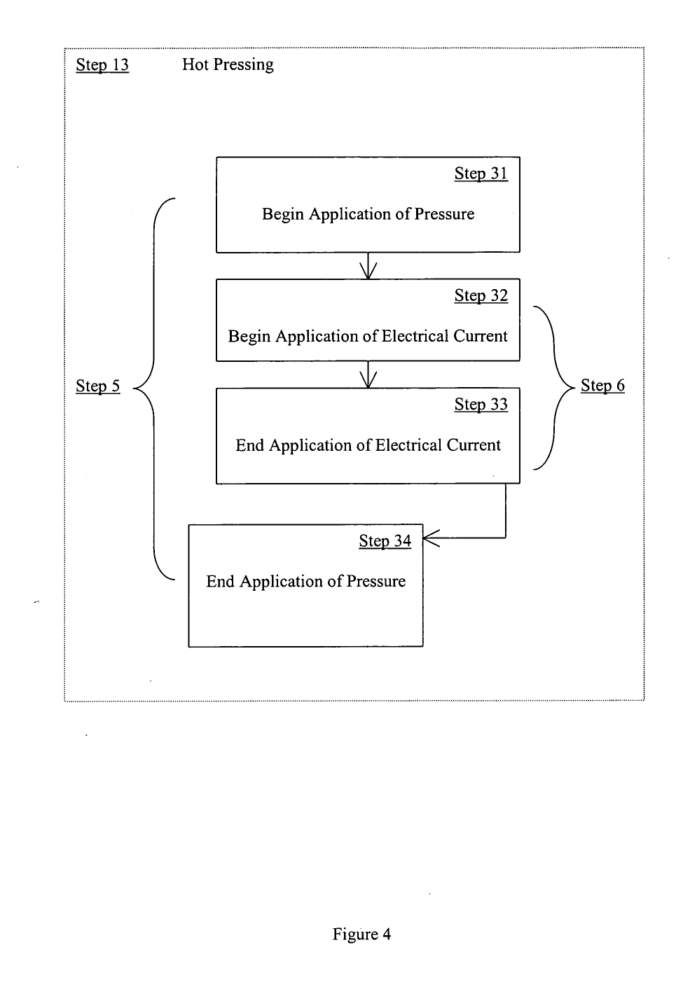

A more preferred process scheme is shown in FIGS. 3 and 4 wherein the hot pressing step (Step 13) includes a programmed application of current and pressure such that the resistive heating step (Step 6) and the compressive molding step (Step 5) provide hot press preform temperatures, pressures, heating rates and pressurization rates in accordance with a desired baking profile, the calculations of which are based upon specific hot press preform kinetics.

The programmed application includes in Step 5: a start of application of pressure (Step 31) to compress the hot press preform, maintaining the application of pressure for a period of time, and an end of application of pressure (Step 34). The level of pressure applied is partly dependent on the desired final density of the carbonized carbon/carbon composite body. In general, a pressure of at least 35 kg/cm² is applied. The applied pressure can be up to about 150 kg/cm², or higher. In a preferred embodiment of Step 5 a control system integral to the hydraulic hot press assembly provides a programmed application of pressure.

The programmed application also includes in Step 6: a start of application of electrical current (Step 32) to resistively heat the hot press preform, maintaining the application of electrical current for a second, overlapping period of time, and an end of application of electrical current (Step 33). In a preferred embodiment of Step 6, the control system provides a programmed application of temperature. It is contemplated that heating may commence concurrently with, or before the start of the application of pressure. It is also contemplated that heating may terminate concurrently with, or after the end of the application of pressure. Preferably, both heating and application of pressure are carried out concurrently, for at least a part of the process time, to densify the material as the volatile components in the matrix materialare driven off.

The temperature of the hot press preform during the hot pressing step (Step 13) is preferably sufficient to melt the matrix material, to optionally remove at least some of the volatiles from the matrix material, and to facilitate compression of the hot press preform as the matrix material is rigidized. In applications of pitch as the matrix material, it should be appreciated that, since pitch is generally not a homogeneous material, a portion of the pitch matrix material may remain unmelted, even at temperatures significantly above the softening point. Additionally, while substantially all the volatiles are removed in this step, it is also contemplated that a portion of the volatiles may remain without unduly affecting the properties of the preform material.

During the hot pressing step (Step 13) of another exemplary process scheme of this invention, the resistive heating rapidly heats the entire hot press preform to a suitable temperature for removal of volatile components and carbonization of the pitch creating voids or gaps within the hot-press preform material. Mechanical pressure is applied to densify the hot press preform as the applied heat drives off the volatile components. The hot press preform preferably reaches a temperature above the carbonization temperature of the matrix material, which is about 500° C. in the case of pitch. For example, the hot press preform is heated to at least about 700° C., more preferably, between about 800° C. and about 900° C., although higher temperatures are also contemplated. The power input applied during resistive heating depends on the resistance of the hot press preform and the desired program temperatures. For a hot press preform including pitch and carbon fibers, a power input of up to about 60 kW/kg is applied, preferably in the range of 45-60 kW/kg, for at least part of the heating process. For example, a power input about 45-60 kW/kg is applied for 90 seconds to 2 minutes, which may be preceded by application of pressure alone for about 3 to 5 minutes.

In a preferred process scheme of this invention, a programmed application of current and pressure process is applied by a programmable control system of the hydraulic press assembly. In one exemplary programmed application process, the control system may initially apply a relatively low power input, preferably in the range of about 30 kW/kg, for a period of time, preferably about 30 seconds, during an initial phase of the compressive and resistive heating. In this phase, the temperature is preferably in the range of about 300° C. to 500° C. The bulk of the volatiles are removed from the hot press preform in this temperature range. At a preprogrammed condition, such as an elapsed time and/or temperature, the temperature is increased to a higher temperature (e.g., above about 700° C., more preferably, 800-900° C.), sufficient to carbonize the matrix material. In this phase, the power input may be from about 45 kW/kg to about 60 kW/kg to bring the temperature up to about 800-900° C. The power is maintained at this level for about 1-2 minutes, or longer.

In such an exemplary programmed application process, the control system may apply different pressures dependent upon preprogrammed conditions, such as, among other things, temperature and process time. The lower pressure may be applied during initial heating so as to reduce the opportunity for volatile comonents to be trapped in the hot press preform and so as to prevent violent disruption of the preform structure as they escape. For example, a pressure of about 35-70 kg/cm² is employed for the first phase, while an increased pressure of about 100-150 kg/cm² is employed for the second phase.

In one embodiment of the process, the hot pressing step (Step 13) takes under three hours, and, preferably, takes about 30 minutes or less. More preferably, the hot pressing step (Steps 13) takes less than about ten minutes, and most preferably takes about 5-8 minutes, which is a much shorter time than the time required in conventional heating/pressing systems. Additionally, the density of the carbonized carbon/carbon composite preform formed in this step is preferably at least 1.3 g/cm³, more preferably, at least 1.4 g/cm³, most preferably, about 1.5 to 1.7 g/cm³. This is much higher than the density generally achieved in conventional methods, where the density of the fiber/matrix preform is about 0.6-1.3 g/cm³ without further densification procedures. As a consequence, fewer carbonizable material infiltration cycles (Steps 8 and 9 as described below) are used to achieve a final desired density (generally 1.7-1.9 g/cm³, more preferably 1.75-1.85 g/cm³) with the resistive heating method than with conventional hot pressing methods. This advantageously decreases the number of processing steps and reduces the overall processing time.

While the carbonized carbon/carbon composite preform is readily formed in the shape of a brake disc, a brake pad or even a rectangular block, it is also contemplated that the hot press mold cavity may be configured to produce a preform of a cylindrical or other shape, thereby reducing or eliminating the need for subsequent machining to form a desired component part.

With reference to FIG. 3, in Step 7 of one preferred process scheme, the carbonized carbon/carbon composite preform is discharged from the hot press mold cavity and cooled. Preferably, the preform is cooled rapidly to a temperature below which oxidation does not occur at a significant rate. For example, the carbonized carbon/carbon composite preform is immersed in water or sprayed with droplets or a mist of water to bring its temperature below about 400-500° C. Alternatively, cooling may be achieved with an inert gas flow. Preferably, the carbonized carbon/carbon composite preform is cooled at a rate to avoid cracking of the carbonized carbon/carbon composite preform due to thermal stresses.

Further densification of the carbon/carbon composite preform takes place in repeatable densification cycles in Steps 8 and 9. In Step 8 a carbonizable material is introduced into the preform body by pitch or resin impregnation. Densification can also be achieved via chemical vapor deposition or infiltration (CVD/CVI). After each impregnation step, the preform is preferably rebaked in Step 9 to carbonize the carbonizable material. It has been found that a target density of about 1.6-1.7 g/cm³ is readily achieved with only a single densification cycle. A density of 1.7 g/cm³, or more, is readily achieved within two such densification cycles. Preferably, the impregnation step (Step 8) is carried out by impregnation of liquid pitch. In this process, the preform is placed in a vacuum chamber and the chamber evacuated. Molten pitch is introduced to the chamber and infiltrates into the evacuated voids in the preform, with the aid of applied pressure.

In Step 9 the body is heated slowly in a furnace, for example, at a heating rate of about 10°C./hour to a final temperature of about 800-900° C. The body is preferably held at this temperature for about 2-3 hours and then the power is removed. The body cools slowly, over a period of two to three days, to a temperature of about 100° C. before being removed from the furnace.

In an alternative densification process, the preform is exposed to an atmosphere of a gaseous hydrocarbon, such methane, ethane, propane, benzene, and the like, or a mixture thereof. The hydrocarbon gas decomposes, or is cracked, for example at about 980° C. to about 1,150° C. to form elemental carbon, which is deposited within the carbon/carbon composite.

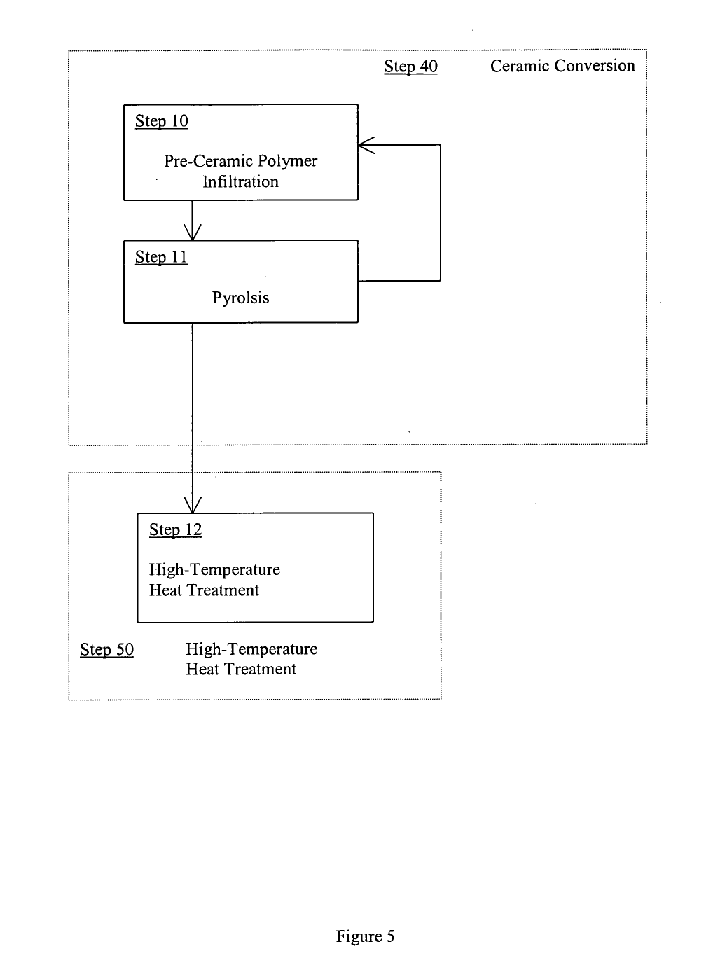

With continued reference to FIG. 1 and now to FIG. 5, a process scheme of the ceramic conversion stage (Step 40) is shown. Deposition of ceramic material within the matrix of the densified carbon/carbon composite preform is accomplished through one or more ceramic conversion cycles (Step 10 and Step 11). In each ceramic conversion cycle (Step 10 and Step 11), a pre-ceramic polymer is introduced into the carbon/carbon composite preform (Step 10) to introduce ceramic components such as SiC into the matrix. The pre-ceramic polymer infiltrated preform is then heat treated (Step 11) to pyrolyze the pre-ceramic polymer. In one embodiment, the pre-ceramic polymer infiltration step (Step 10) is accomplished in an impregnation vacuum chamber. In an alternative embodiment, the Step 10 and Step 11 are accomplished by chemical vapor deposition or infiltration (CVD/CVI). In another alternative embodiment, the pre-ceramic polymer infiltration step (Step 10) is accomplished by application of a silicon based pre-ceramic polymer gel or liquid solution. After each pre-ceramic polymer infiltration step (Step 10) the pre-ceramic polymer infiltrated preform is preferably baked in Step 11 to pyrolyze the pre-ceramic polymer. In this step, the pre-ceramic preform is heated in an inert atmosphere, for example, in an induction furnace, to a temperature of about 500° C., or higher, and more preferably, to a temperature of between about 1500° C. and about 1700° C., to completely pyrolyze the pre-ceramic polymer. Advantageously, this process of making CRFC composites creates a higher degree of SiC/C integration and, thus, better microstructures than previous methods of making CRCF composites.

This invention contemplates the use of various pre-ceramic polymers. In one example, the pre-ceramic polymers of this invention include organosilicon pre-ceramic polymers such as polysilane, polycarbosilane, polysiloxane, polysilazane, polysilsesquioxanes polysilane, silicon resin or silicon-carboxyl. This invention can also be practiced with organometallic pre-ceramic polymers. In one embodiment, the organometallic pre-ceramic polymer is selected from the group consisting of polyorganozirconates, polyorganoaluminates, polysiloxanes, polysilanes, polysilazanes, polyphosphazenes, polyorganotitanates and mixtures thereof. It is contemplated that the method of this invention can be practiced with a wide range of pre-ceramic polymers.

With continued reference to FIG. 1 and to FIG. 5, a preferred process scheme of the high-temperature heat treatment stage (Step 50) is shown wherein the carbon/ceramic preform is directly subjected to a high-temperature heat treatment process (Step 12). In this step, the carbon/ceramic preform is heated in an inert atmosphere, for example, in an induction furnace, to a temperature of about 1500° C., or higher, more preferably, about 2000° C., most preferably, about 2500° C., to remove all (or substantially all) hydrogen and other heteroatoms and produce a finished CRFC structure, such as a CRCF brake pad or CRCF brake disc. Above about 2400° C., the carbon/ceramic composite is fully graphitized. The final heat treatment temperature is selected according to the end use of the finished product. The period of time for this procedure is calculated using conventional calculations based upon heat treatment time/temperature kinetics, taking into account furnace thermal load and mass.

During this high-temperature heat treatment process, various physical properties of the carbon/ceramic composite material, such as its mechanical strength and durability properties and its thermal conductivity, are substantially improved, making the composite material suitable for various high temperature commercial applications. Advantageously, this process of making CRFC composites consumes no carbon and, thus, preserves the graphite's superior properties.

The resulting CRFC material is suited to a wide range of applications, including use as brake components, antiskid components, structural components, body panels, pistons, and cylinders, for vehicles, aircraft, trains, and aerospace vehicles, missile components, and susceptors used in furnaces. The reduction in processing time achieved with the resistive heating method opens up many other applications for the material which have hitherto been impractical because of time and production cost constraints.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. A method of forming a carbon-fiber reinforced ceramic composite material comprising the steps of:
(a) providing an at least partially carbonized carbon/carbon composite preform;
(b) introducing a pre-ceramic polymer into voids of the carbonized carbon/carbon composite preform so as to form a pre-ceramic preform;
(c) heating the pre-ceramic preform to a sufficient temperature so as to form a ceramic preform by pyrolytically decomposing the pre-ceramic polymer; and
(d) heating the ceramic preform to a sufficient temperature so as to form a carbon fiber reinforced ceramic structure by high-temperature heat treating the carbon/ceramic composite.

2. The method of claim 1, wherein the pre-ceramic polymer of step (b) comprises an organosilicon pre-ceramic polymer.

3. The method of claim 2, wherein the organosilicon pre-ceramic polymer comprises a pre-ceramic polymer selected from the group consisting of polysilane, polycarbosilane, polysiloxane, polysilazane, polysilsesquioxanes polysilane, silicon resin, silicon-carboxyl and combinations thereof.

4. The method of claim 1, wherein step (c) includes heating the pre-ceramic preform in an inert atmosphere to a final temperature of at least about 500° C.

5. The method of claim 1, wherein step (c) includes heating the pre-ceramic preform in an inert atmosphere to a final temperature between about 1500° C. to about 1700° C.

6. The method of claim 1, wherein step (d) includes heating the ceramic preform in an inert atmosphere to a final temperature between about 1500° C. to about 2500° C.

7. The method of claim 1, wherein step (d) includes heating the ceramic preform in an inert atmosphere to a final temperature of about 2500° C.

8. The method of claim 1, further comprising the step of:
increasing the density of the carbonized carbon/carbon composite preform, said densification including the steps of:
introducing a carbonizable material into voids in the carbonized carbon/carbon composite preform; and
heating the carbonized carbon/carbon composite preform so as to at least partially carbonize the carbonizable material introduced into the voids in the carbonized carbon/carbon composite preform.

9. The method of claim 1, wherein step (a) comprises the steps of:
providing a green preform comprising a reinforcement material and a carbonizable matrix material;
resistively and compressively heating the green preform so as to form the at least partially carbonized carbon/carbon composite preform, the step of resistively and compressively heating including:
applying an electric current to the green preform to generate heat within the green preform; and
applying a pressure to the green preform.

10. The method of claim 9, wherein the step of resistively and compressively heating the green preform includes:
a programmed application of said electric current and said pressure for a process time, said programmed application adapted to control the pressure of the green preform.

11. The method of claim 9, wherein the step of resistively and compressively heating the green preform includes converting the matrix material to an infusible material.

12. The method of claim 9, wherein said reinforcement material comprises carbon fiber, and
wherein step (a) further comprises the step of combining the reinforcement material and the carbonizable matrix material so as to form the green preform.

13. The method of claim 9, wherein the carbon fibers include fibers selected from the group consisting of mesophase pitch carbon fibers, isotropic pitch carbon fibers, carbonized rayon fibers, cotton fibers, polyacrylonitrile (PAN) fibers, cellulose fibers, and combinations thereof.

14. The method of claim 9, wherein the matrix material is selected from the group consisting of phenolic resins, furan resins, coal tar pitch, petroleum pitch, and combinations thereof

15. A method of forming a carbon fiber reinforced ceramic body comprising the steps of:
(a) providing a carbonizable green preform comprising a reinforcement material and a carbonizable matrix material;
(b) compressing the carbonizable green preform;
(c) during the step of compressing, applying a current to the preform, the preform providing a sufficient electrical resistance to the current such that the preform reaches a temperature sufficient to form an at least partially carbonized carbon/carbon composite preform;
(d) introducing a pre-ceramic silicon-containing polymer material into the carbonized carbon/carbon composite preform;
(e) heating the product of step (d) so as to pyrolytically decompose the pre-ceramic silicon-containing polymer to introduce SiC into the matrix of the carbon/carbon composite preform; and
(f) high-temperature, heat treaing the ceramic preform to a final temperature of at least about 1500° C. to form the carbon/ceramic composite body.

16. The method of claim 16, further including the steps of:
introducing a resin or pitch material into the carbon/carbon composite preform; and
heating the product of the resin or pitch material introduction step so as to carbonize the resin or pitch material.

17. The method of claim 16 further including the steps of:
providing a hot press assembly, said hot press assembly having:
a hydraulic press;
a hot press mold having a shaped mold cavity, said cavity including electrical contacts; and
an electrical power supply circuitry adapted to provide an electrical current to the hot press mold;
placing said green preform within said cavity; and
operating said hot press assembly so as to accomplish steps (b) and (c).

18. The method of claim 16, step (a) further including the steps of:
providing a preform skeleton positioned within a resin transfer mold, the preform skeleton comprising carbon reinforcement materials including carbon fibers;
introducing a liquid matrix material into the resin transfer mold and upon the preform skeleton so as to cover the carbon fibers; and
solidifying the liquid matrix material so as to form a carbonizable green preform.

19. The method of claim 19, wherein the liquid matrix material comprises a low-viscosity resin, and
wherein the step of introducing the low-viscosity resin within the resin transfer mold and upon the preform skeleton is accomplished by drawing the resin within the mold and onto the preform through the use of a vacuum.
